(19) United States
(12) Patent Application Publication
(10) Pub. No.: US 2025/0247609 A1
(43) Pub. Date: Jul. 31, 2025

(54) ELECTRONIC DEVICE AND CONTROL METHOD THEREFOR

(71) Applicant: SAMSUNG ELECTRONICS CO., LTD., Suwon-si (KR)

(72) Inventors: Trishna CHAKRABORTY, Dhaka (BD); Md. Imtiaz HOSSAIN, Dhaka (BD); Md. Jobed HOSSAIN, Dhaka (BD); Imranur RAHMAN, Dhaka (BD)

(73) Assignee: SAMSUNG ELECTRONICS CO., LTD., Suwon-si (KR)

(21) Appl. No.: 19/184,769

(22) Filed: Apr. 21, 2025

Related U.S. Application Data
(63) Continuation of application No. PCT/KR2023/015670, filed on Oct. 12, 2023.

(30) Foreign Application Priority Data
Nov. 8, 2022 (KR) 10-2022-0148016

(51) Int. Cl. H04N 23/63; G06T 7/68; H04N 23/53; H04N 23/60; H04N 23/667; H04N 23/67

(52) U.S. Cl. CPC H04N 23/632; G06T 7/68; H04N 23/64; H04N 23/667; H04N 23/67; H04N 23/531

(57) ABSTRACT

An electronic device and a control method therefor are provided. The electronic device includes a camera, a display, a memory storing at least one instruction and at least one processor that is connected with the camera, the display, and the memory. The at least one processor, by executing the at least one instruction, is configured to: control the display to display a preview based on an image obtained by the camera, based on a selection of a first photographing mode, search for a symmetric object among a plurality of objects in the image, and perform a focusing operation on the symmetric object.

### CROSS-REFERENCE TO RELATED APPLICATION

This application is a bypass continuation of International Application No. PCT/KR2023/015670, filed on Oct. 12, 2023, which is based on and claims priority to Korean Patent Application No. 10-2022-0148016, filed on Nov. 8, 2022, in the Korean Patent Office, the disclosures of which are incorporated by reference herein in their entireties.

### BACKGROUND

### 1. Field

The disclosure relates to an electronic device and a method of controlling the electronic device, and more particularly, to an electronic device that includes a camera having a plurality of photographing modes, and a method of controlling the electronic device.

### 2. Description of Related Art

Recently, as camera and software technologies have developed, various photographing modes are being provided to electronic devices including the camera. For example, an electronic device provides various photographing modes such as a panorama photographing mode, a selfie photographing mode, etc. When an electronic device enters each photographing mode, the electronic device performs image processing by changing the camera setting to correspond to the photographing mode, or performs image processing by using software corresponding to the photographing mode.

Meanwhile, recently, puddlegram images including objects which are buildings or natural environments that are reflected by fluids and are expressed symmetrically (referred to as “symmetric objects” hereinafter) are in fashion. Accordingly, search for a method for effectively photographing a puddlegram image is needed.

### SUMMARY

According to an aspect of the disclosure, there is provided an electronic device including: a camera including a plurality of lenses; a display; a memory storing at least one instruction; and at least one processor that is connected with the camera, the display, and the memory, and, by executing the at least one instruction, configured to: control the display to display a preview based on an image obtained by the camera, based on a selection of a first photographing mode, search for a symmetric object among a plurality of objects in the image, and perform a focusing operation on the symmetric object.

According to another aspect of the disclosure, there is provided a control method for an electronic device, the method including: displaying a preview based on an image obtained by a camera of the electronic device; based on a selection of a first photographing mode, searching for a symmetric object among a plurality of objects in the image; and performing a focusing operation on the symmetric object.

According to another aspect of the disclosure, there is provided a non-transitory computer readable medium including a program for executing a control method for an electronic device, the method including: displaying a preview based on an image obtained by a camera of the electronic device; based on a selection of a first photographing mode, searching for a symmetric object among a plurality of objects in the image; and performing a focusing operation on the symmetric object.

### BRIEF DESCRIPTION OF DRAWINGS

FIG. 1 is a diagram for illustrating an image including a symmetric object according to an embodiment of the disclosure;

FIG. 2 is a block diagram illustrating a configuration of an electronic device according to an embodiment of the disclosure;

FIG. 3 is a flowchart for illustrating a method of performing focusing on a symmetric object while operating in a puddlegram photographing mode according to an embodiment of the disclosure;

FIG. 4 are diagrams for illustrating a symmetry map according to an embodiment of the disclosure;

FIG. 5 is a diagram showing a highlight displayed on a symmetric object according to an embodiment of the disclosure;

FIG. 6 is a flowchart for illustrating a method of providing a guide UI that guides such that a symmetric axis is located in a first area while operating in a puddlegram photographing mode according to an embodiment of the disclosure;

FIG. 7A to FIG. 7C are diagrams for illustrating a method of providing a guide UI while operating in a puddlegram photographing mode according to an embodiment of the disclosure;

FIG. 8 is a flowchart for illustrating a method of providing a guide UI that guides such that a symmetric axis is located in a first area corresponding to a preference model while operating in a puddlegram photographing mode according to an embodiment of the disclosure;

FIG. 9A and FIG. 9B are flowcharts for illustrating a method of performing a puddlegram photographing mode by using a plurality of lenses according to an embodiment of the disclosure;

FIG. 10A to FIG. 10D are diagrams for illustrating a method of performing a puddlegram photographing mode by using a plurality of lenses according to an embodiment of the disclosure;

FIG. 11A to FIG. 11C are diagrams for illustrating form factors of an electronic device according to various embodiments of the disclosure;

FIG. 12A to FIG. 12C are diagrams for illustrating a method of performing a puddlegram photographing mode according to form factors of an electronic device according to various embodiments of the disclosure;

FIG. 13 is a flowchart for illustrating a method of providing a guide UI that guides folding or unfolding of an electronic device such that a symmetric axis is located in a first area while operating in a puddlegram photographing mode according to an embodiment of the disclosure;

FIG. 14A to FIG. 14C are diagrams illustrating a guide UI that guides folding or unfolding of an electronic device such that a symmetric axis is located in a first area while operating in a puddlegram photographing mode according to an embodiment of the disclosure;

FIG. 15 is a flowchart for illustrating a method of providing a guide UI that guides a movement of an electronic device to detect a symmetric object while operating in a puddlegram photographing mode according to an embodiment of the disclosure;

FIG. 16 is a flowchart for illustrating a method of providing an image filter effect on a reflective surface while operating in a puddlegram photographing mode according to an embodiment of the disclosure;

FIG. 17A to FIG. 17C are diagrams for illustrating an image filter effect provided on a reflective surface according to form factors of an electronic device according to various embodiments of the disclosure;

FIG. 18A to FIG. 18C are diagrams for illustrating a method of performing post-processing on a boundary surface of an electronic device according to an embodiment of the disclosure; and

FIG. 19 is a flowchart for illustrating a method of entering a puddlegram photographing mode automatically according to a folding angle of an electronic device according to an embodiment of the disclosure.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

On the other hand, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Further, in the embodiments of the disclosure, ‘a module’ or ‘a unit’ may perform at least one function or operation, and may be implemented as hardware or software, or as a combination of hardware and software. Also, a plurality of ‘modules’ or ‘units’ may be integrated into at least one module and implemented as at least one processor, excluding ‘a module’ or ‘a unit’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, embodiments according to the disclosure will be described in detail with reference to the accompanying drawings, such that those having ordinary skill in the art to which the disclosure belongs can easily carry out the embodiments.

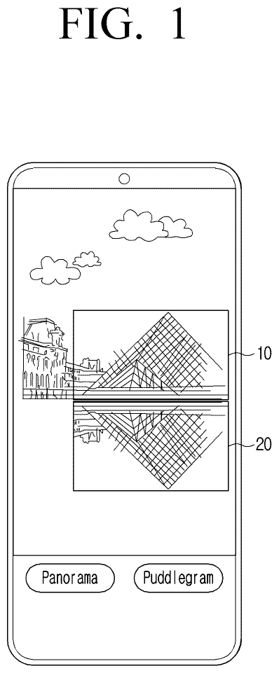

According to one or more embodiments of the disclosure, “a puddlegram image” may be an image including a symmetric object. Here, the symmetric object may include an object and a reflective object which is an object reflected by a reflective surface. For example, as illustrated in FIG. 1, a puddlegram image may be an image including a building 10 in a pyramid shape, and a reflective object 20. For example, the reflective object is the building 10 reflected by fluid (e.g., water).

A puddlegram photographing mode according to an embodiment of the disclosure is one of a plurality of photographing modes operable by an electronic device. For example, the puddlegram photographing mode may be a mode for photographing a puddlegram image. The electronic device 100 may search a symmetric object from an image photographed by a camera while operating in the puddlegram photographing mode, and perform focusing for the searched symmetric object. Also, the electronic device 100 may provide a guide user interface (UI) for guiding the location of the symmetric object while operating in the puddlegram photographing mode.

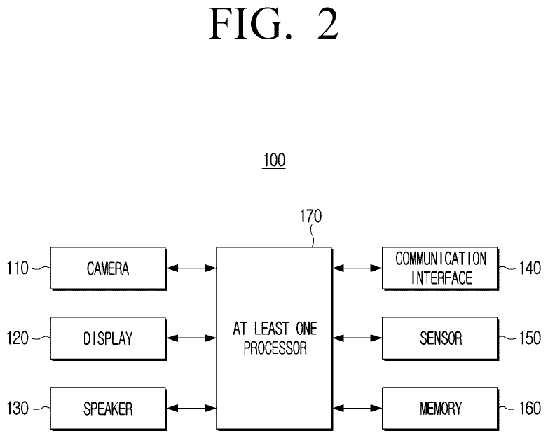

Hereinafter, the disclosure will be described in more detail with reference to the drawings. FIG. 2 is a block diagram illustrating an element of an electronic device according to an embodiment of the disclosure. As illustrated in FIG. 2, the electronic device 100 may include a camera 110, a display 120, a speaker 130, a communication interface 140, a sensor 150, memory 160, and at least one processor 170. Here, the electronic device 100 may be implemented as a smartphone, but this is merely an example, and the electronic device 100 can be implemented as another portable terminal device that can photograph images (e.g., a tablet PC, a smart watch, etc.). Also, the components illustrated in FIG. 1 are merely an example, and as such, according to another embodiment, some components can be added or deleted according to the type of the electronic device 100.

The camera 110 is a component for obtaining image data that photographed the surroundings of the electronic device 100. In particular, the electronic device 100 may include at least one camera on a plurality of surfaces of the electronic device 100. For example, the electronic device 100 may include a first camera on the front surface of the electronic device 100 (the surface on which the display 120 is arranged), and may include a second camera on the rear surface of the electronic device 100 (the opposite surface of the front surface).

Also, the camera 110 may include a plurality of lenses. The plurality of lenses may include a wide-angle lens (or referred to as a main lens), a telephoto lens, and an ultra wide-angle lens, etc. Alternatively, each lens may be implemented as a separate camera, and the electronic device 100 can include a wide-angle camera, a telephoto camera, and an ultra wide-angle camera.

In particular, the camera 110 may perform auto focusing, and it may particularly perform focusing for a symmetric image while operating in the puddlegram photographing mode.

The display 120 is a component that displays image data, and it may be implemented as a display including self-luminescence elements, or a display including non-self-luminescence elements and a backlight. For example, the display 120 may be implemented as various forms of displays such as a liquid crystal display (LCD), an organic light emitting diodes (OLED) display, light emitting diodes (LED), micro LED, mini LED, a plasma display panel (PDP), a quantum dot (QD) display, quantum dot light emitting diodes (QLED), etc. Inside the display 120, driving circuits that may be implemented in forms such as an a-si TFT, a low temperature poly silicon (LTPS) TFT, an organic TFT (OTFT), etc., and a backlight unit, etc. may also be included.

Also, the display 120 may display a preview obtained based on an image photographed through the camera 110. In addition, while operating in the puddlegram photographing mode, the display 120 may display a highlight for identifying a symmetric object on the preview, a symmetric axis of the symmetric object, a guide UI for guiding the location of the symmetric object, etc.

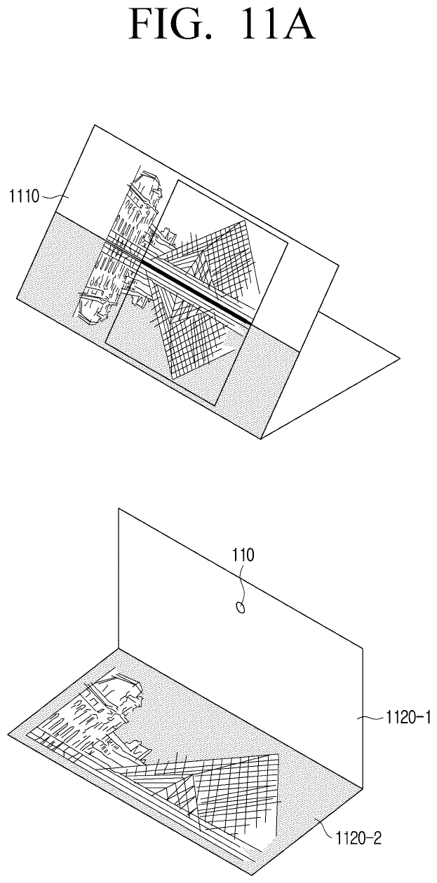

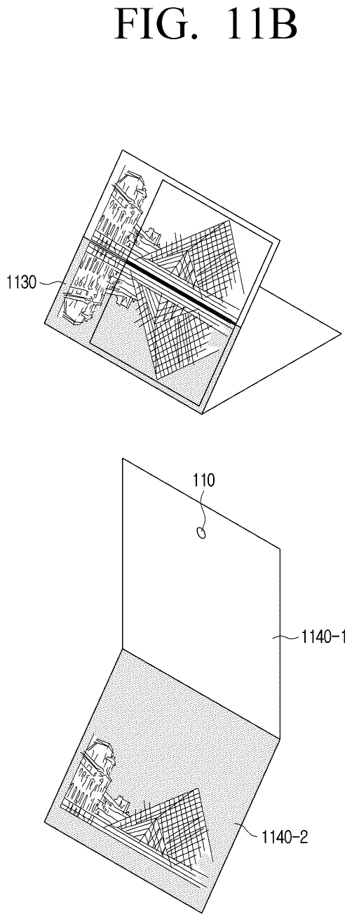

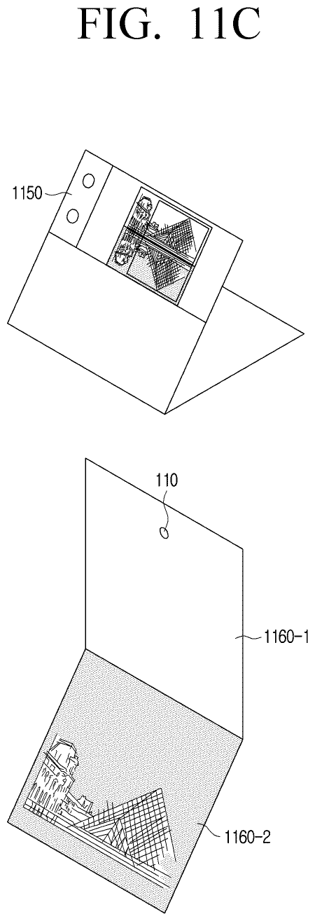

According to an embodiment, the display 120 may be implemented as a flexible display. Detailed explanation in this regard will be described later with reference to FIG. 11A to FIG. 11C.

The speaker 130 may output various voice messages and audio data. According to an embodiment, the speaker 130 may be provided inside the electronic device 100, but this is merely an example, and the speaker 130 may be provided outside the electronic device 100 and may be electrically connected with the electronic device 100. In particular, the speaker 130 may output a voice guide for guiding the location of the symmetric object while operating in the puddlegram photographing mode.

The communication interface 140 may include at least one circuit, and perform communication with various types of external devices. The communication interface 140 may include at least one of a Bluetooth Low Energy (BLE) module, a Wi-Fi communication module, a cellular communication module, a third generation (3G) mobile communication module, a fourth generation (4G) mobile communication module, a fourth generation long term evolution (LTE) communication module, or a fifth generation (5G) mobile communication module.

The communication interface 140 may download a camera application that provides a puddlegram photographing mode from an external server.

The sensor 150 may obtain information on the state of the electronic device 100 or the ambient environment of the electronic device 100. In particular, the sensor 150 may include at least one sensor for detecting the movement and the posture of the electronic device 100 (e.g., an acceleration sensor, a gyro sensor, a geomagnetic sensor, etc.), and include at least one sensor for detecting the outside environment (an illumination sensor, a distance sensor, etc.). Other than the above, the sensor 150 may include a sensor for detecting the state of the user (e.g., a heartrate sensor, an electrocardiogram sensor, a blood pressure sensor, etc.).

The memory 160 may store an operating system (OS) for controlling the overall operations of the components of the electronic device 100 and instructions or data related to the components of the electronic device 100. In particular, the memory 160 may store data related to the puddlegram photographing mode, and store an image photographed during the puddlegram photographing mode.

According to an embodiment, the memory 160 may be implemented as non-volatile memory (ex: a hard disk, a solid state drive (SSD), flash memory), volatile memory (may include memory inside the at least one processor 170, etc.

The at least one processor 170 may be electrically connected with the memory 160, and control the overall functions and operations of the electronic device 100. In particular, the at least one processor 170 controls the display 120 to display a preview based on an image obtained by the camera 110 by executing the at least one instruction stored in the memory 160. In an example case in which a user instruction selecting the first photographing mode (or the puddlegram photographing mode) is input, the at least one processor 170 searches a symmetric object among objects included in an image. Then, the at least one processor 170 performs focusing for the searched symmetric object.

In particular, the at least one processor 170 may obtain a symmetry map by using a symmetry detection algorithm. Then, the at least one processor 170 may search a symmetric object among objects included in an image by using the symmetry map. Then, the at least one processor 170 may control the display 120 to display a highlight corresponding to the searched symmetric object on the preview.

Also, the at least one processor 170 may identify the symmetric axis of the symmetric object by using the symmetry map. The at least one processor 170 may control the display 120 to display the identified symmetric axis on the preview. The at least one processor 170 may determine whether the location of the symmetric axis is located in the first area in the preview. Based on a determination that the location of the symmetric axis is beyond the first area in the preview, the at least one processor 170 may control the display 110 to display a first guide UI guiding a movement of the electronic device such that the symmetric axis is located in the first area on the preview. Here, the first area may be determined according to a photographing direction of a symmetric object included in puddlegram images photographed by the user, the location of the symmetric object in the preview, and a ratio of the symmetric object included in the puddlegram images.

In addition, the at least one processor 170 may control the display 120 to display a first preview based on a first image photographed by using a first lens among the plurality of lenses. In an example case in which a user instruction selecting the first photographing mode is input while displaying the first preview, the at least one processor 170 may obtain a second image in the background by using a second lens different from the first lens among the plurality of lenses. In an example case in which the symmetric object is not searched in the first image, but the symmetric object is searched in the second image, the at least one processor 170 may control the display 120 to convert the first preview into a second preview obtained based on the second image. The at least one processor 170 may identify the symmetric axis of the symmetric object included in the second image. The at least one processor 170 may control the display 120 to display the identified symmetric axis on the second preview.

According to an embodiment, the electronic device 100 may further include a hinge part that makes the electronic device 100 folded or unfolded, and here, the display may be implemented as a flexible display that is folded or unfolded as the electronic device 100 is folded or unfolded centered around the hinge part. In an example case in which a user instruction selecting the first photographing mode is input while the electronic device 100 is folded by a first angle by the hinge part, the at least one processor 170 may identify a symmetric axis of a symmetric object generated by a reflective surface among a plurality of surfaces included in the electronic device 100 among the objects included in the image, and control the display 120 to display the symmetric axis on the preview. The at least one processor 170 may determine whether the location of the symmetric axis is located in the first area in the preview. Based on a determination that the location of the symmetric axis is beyond the first area in the preview, the at least one processor 170 may control the display 120 to display a second guide UI guiding to adjust a folding angle of the electronic device so as to locate the symmetric axis in the first area on the preview.

In an example case in which a user instruction selecting the first photographing mode is input while the electronic device 100 is folded by the first angle by the hinge part, the at least one processor 170 may determine whether a symmetric object is searched among objects included in an image photographed by the ultra wide-angle lens among the plurality of lenses. In an example case in which a symmetric object is not searched, the at least one processor 170 may control the display 120 to display a third guide UI guiding such that the electronic device 100 is moved to be closer to an object on the preview.

Also, the at least one processor 170 may control the display 120 to display an image filter effect in at least some parts of the display which is a reflective surface.

Then, the at least one processor 170 may determine a recommended image filter effect for recommending to the user based on information on the ambient brightness detected by the sensor 140, information on colors included in the image, and information on the objects included in the image. In an example case in which the recommended image filter effect is selected, the at least one processor 170 may control the display 120 to display the recommended image filter effect in at least some parts of the display which is a reflective surface.

In an example case in which a camera application is executed while the electronic device 100 is folded by the first angle by the hinge part, the at least one processor 170 may enter the photographing mode automatically as the first photographing mode, and operate in the first photographing mode.

Hereinafter, various embodiments of the disclosure will be described with reference to the drawings.

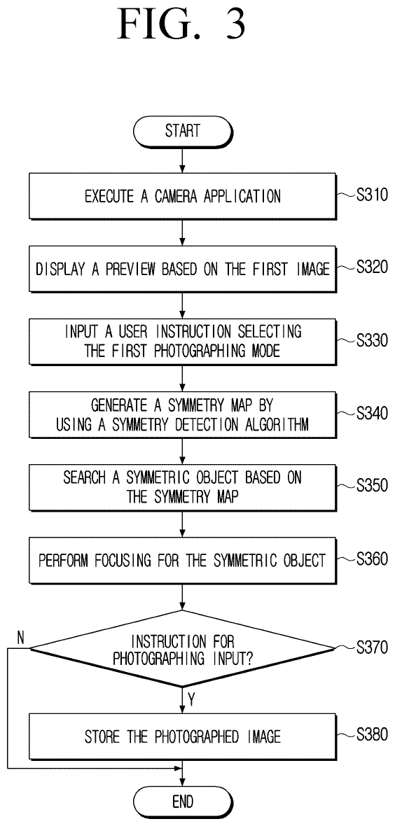

FIG. 3 is a flowchart for illustrating a method of performing focusing on a symmetric object while operating in a puddlegram photographing mode according to an embodiment of the disclosure. For example, the electronic device 100 may search a symmetric object while operating in the puddlegram photographing mode, and display a highlight for the searched object (e.g., highlight the searched object) and perform a focusing operation.

According to an embodiment, in operation S310, the electronic device 100 may execute a camera application. For example, in a case in which a user input for executing the camera application (e.g., a user input selecting the icon of the camera application) is received, the electronic device 100 may execute the camera application, and display an execution screen of the camera application.

According to an embodiment, in operation S320, the electronic device 100 may display a preview based on the first image. For example, the electronic device 100 may display the preview based on the first image photographed through a wide-angle lens in the camera 110. For example, the electronic device 100 may display the preview by performing imaging processing on the first image, but this is merely an example, and the electronic device 100 may display the first image itself as the preview.

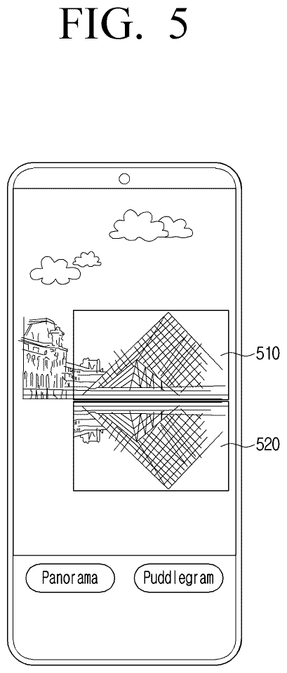

According to an embodiment, in operation S330, the electronic device 100 may receive input of a user instruction selecting the first photographing mode. For example, the electronic device 100 may receive input of a user instruction selecting an icon corresponding to the first photographing mode (e.g., the puddlegram photographing mode) among the icons displayed on the preview. For example, the icon may be a “puddlegram icon” as illustrated in FIG. 5. In an example case in which the user instruction selecting the first photographing mode is input, the electronic device 100 may operate in the first photographing mode.

According to an embodiment, in operation S340, the electronic device 100 may generate a symmetry map. For example, the electronic device 100 may generate the symmetry map by using a symmetry detection algorithm. For example, the electronic device 100 may obtain mirror reflection of each pixel for an input image, and obtain a confidence score related to an amount of the mirror reflection among pixels using through a scale invariant feature transform (SIFT) algorithm. For example, the electronic device 100 may obtain a first symmetry map indicating mirror reflection of each pixel (a nearest mirror reflection field (NMRF)), and obtain a second symmetry map (a symmetry score map (SSM)) indicating a confidence score that measured similarity between a pixel and a pixel which went through mirror reflection. Then, the electronic device 100 may obtain a final symmetry map by using the first symmetry map and the second symmetry map.

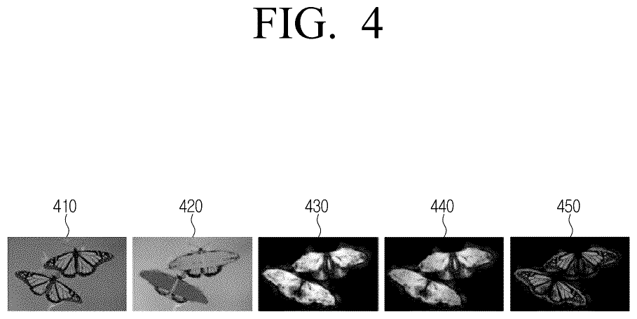

Referring to FIG. 4, in an example case in which an image 410 is obtained, the electronic device 100 may obtain a map 420 indicating a mirror reflection point pair. Here, the map 420 may include at least two different colors, and the different colors included in the map 420 may indicate different clusters. According to an embodiment, the electronic device 100 may obtain the second symmetry map (the SSM(S)) by using a grayscale image 430, and may obtain the first symmetry map (the NMRF(f)) by using an HSV color image 440. According to an embodiment, the electronic device 100 may obtain a final symmetry map (Im) 450 indicating the degree of mirror reflection of each pixel based on the first symmetry map 440 (the NMRF(f)) and the second symmetry map (the SSM(S)) 40. For example, the electronic device 100 may obtain the final symmetry map (Im) through a formula as follows.

$$Im ( Q ) = S ( Q ) \int ( Q ) , ∀ Q ∈ W \times H \qquad [ Formula 1 ]$$

Here, Im indicates the final symmetry map, f(Q) indicates the first symmetry map, S(Q) indicates the second symmetry map, and W×H indicate the pixels of an input image.

According to an embodiment, generating a symmetry map as described above is merely an example, and a symmetry map can be generated by different methods.

According to an embodiment, in operation S350, the electronic device 100 may search a symmetric object based on the symmetry map. For example, the electronic device 100 may identify a symmetric axis from the symmetry map, and search a symmetric object based on the identified symmetric axis. Here, as illustrated in FIG. 1, the symmetric object may be a reflective symmetric object including the object 10 and a reflective object 20 which is the object reflected by the reflective surface.

Here, in an example case in which a symmetric object is searched, the electronic device 100 may highlight the searched symmetric object as illustrated in FIG. 5. For example, as illustrated in FIG. 5, the electronic device 100 may display highlights for each of the object 510 and the reflective object 520, but this is merely an example, and the electronic device 100 can display one highlight for a symmetric object including an object and a reflective object. For example, highlighting the searched symmetric object may include displaying a boarder around the search symmetric object, but the disclosure is not limited thereto.

According to an embodiment, in operation S360, the electronic device 100 may perform focusing operation on the searched symmetric object. For example, the electronic device 100 may focus on the searched symmetric object. Here, in an example case in which a plurality of symmetric objects are searched, the electronic device 100 can perform focusing operation on each of the plurality of objects.

According to an embodiment, in operation S370, the electronic device 100 may determine whether an instruction for photographing was input or received. Here, the instruction for photographing may be an instruction received from a user for selecting an icon included in the display 120, but this is merely an example, and as such, according to another example, the instruction for photographing may be an instruction selecting a separate physical photographing button, etc.

According to an embodiment, in an example case in which the instruction for photographing is input in the operation S370 (e.g., S370—Y), the electronic device 100 may store the photographed image in the operation S380.

According to an embodiment, in the aforementioned embodiment, it was explained that the user enters the first photographing mode by directly selecting the first photographing mode, but this is merely an example. As such, according to another embodiment, in an example case in which a symmetric object is searched in the first image by first performing operations S340 and S350, the electronic device 100 may enter the first photographing mode. In another embodiment, in an example case in which a symmetric object is searched in the first image by first performing operations S340 and S350, the electronic device 100 may display an icon for entering the first photographing mode. In an example case in which the displayed icon is selected, the electronic device 100 may enter the first photographing mode.

According to an embodiment, for photographing an optimal puddlegram image while operating in the first photographing mode, the electronic device 100 may display a guide UI guiding a movement of the electronic device 100 such that the symmetric axis is moved to a predetermined area.

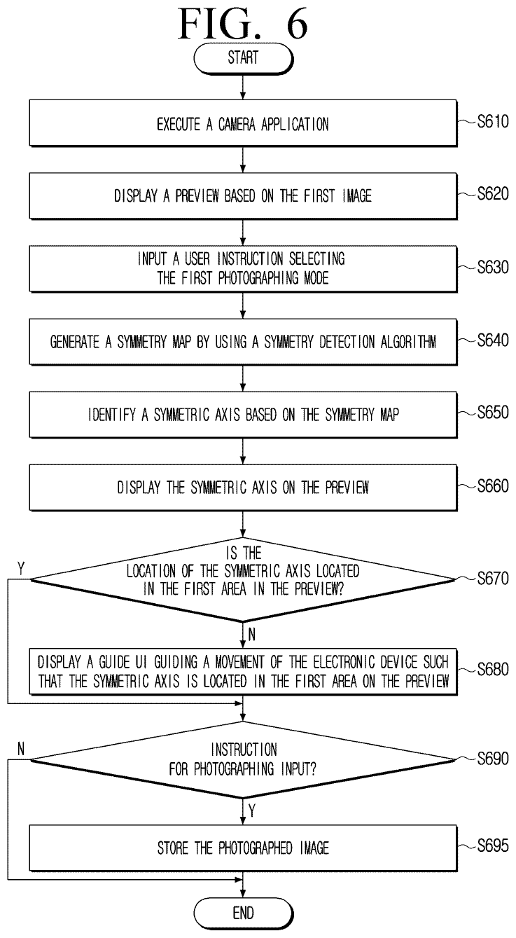

FIG. 6 is a flowchart for illustrating a method of providing an user interface (e.g., a guide UI) for guiding a user such that a symmetric axis is located in a first area while operating in a puddlegram photographing mode according to an embodiment of the disclosure. According to an embodiment, as operations S610 to S640 may be identical to the operations S310 to S340 explained in FIG. 3, overlapping explanation will be omitted.

According to an embodiment, in operation S650, the electronic device 100 may identify a symmetric axis based on the symmetry map. For example, as illustrated in the map 420 in FIG. 4, the electronic device 100 may identify at least one symmetric axis from the symmetry map.

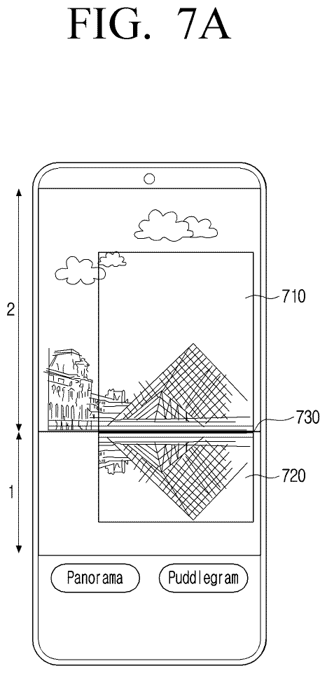

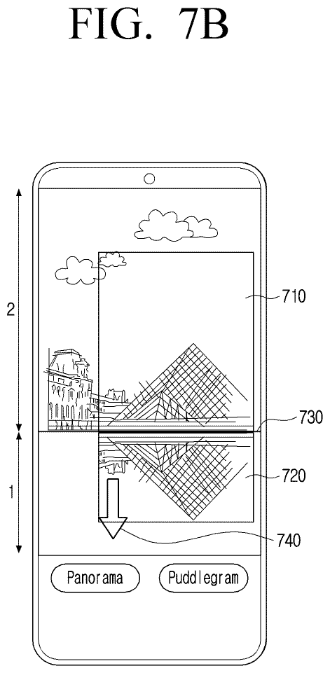

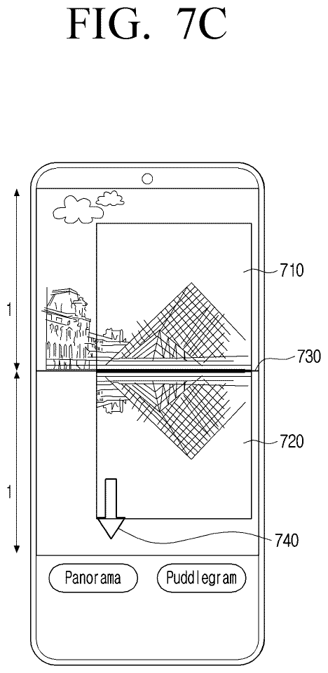

According to an embodiment, in operation S660, the electronic device 100 may display the symmetric axis on a preview or a preview image. Here, as explained in FIG. 3, the electronic device 100 may display a highlight for the symmetric object, and display the symmetric axis together. For example, as illustrated in FIG. 7A, the electronic device 100 may display a symmetric axis 730 together with the highlighted portions 710, 720 for the symmetric object. According to an embodiment, the highlighted portions 710 and 720 are depicted by a rectangular box in FIG. 7A. However, the disclosure is not limited thereto, and as such, according to another embodiment, the symmetric object may be highlighted in a different manner. For example, the symmetric object may be highlighted with a shaded region or a region with a different color.

According to an embodiment, in operation S670, the electronic device 100 may determine whether the location of the symmetric axis is located in the first area in the preview. Here, the first area is a predetermined area for photographing an optimal puddlegram image. For example, the first area may be the central area of the preview. Here, the central area may be an area that divides the preview in 1:1.

According to an embodiment, based on a determination that the location of the symmetric axis is beyond the first area in the preview in the operation S670 (e.g., S670—N), the electronic device 100 may display a guide UI guiding a movement of the electronic device 100 such that the symmetric axis is located in the first area on the preview in operation S680. For example, as illustrated in FIG. 7A, in an example case in which the location of the symmetric axis is located in an area that divides the preview in 2:1, the electronic device 100 may determine that the location of the symmetric axis is not located in the first area. In an example case in which the location of the symmetric axis is not located in the first area, as illustrated in FIG. 7B, the electronic device 100 may display a guide UI 740 guiding the electronic device 100 to move downward such that the location of the symmetric axis can be located in the first area. Here, as illustrated in FIG. 7B, the electronic device 100 may display the guide UI 740 in the form of an arrow guiding directions, but this is merely an example, and as such, according to another embodiment, the guide UI 740 may display guide information in another manner. For example, a text message or a voice message for guiding the movement of the electronic device 100 can be provided with or without the arrow.

In addition, while it was explained in FIG. 7B that a guide UI in the form of an arrow that moves the electronic device 100 (or the camera 110) in up and down directions is provided, this is merely an example. As such, according to another embodiment, a guide UI that guides zoom-in/zoom-out or guides the camera to rotate (for example, rotation in a pitch direction) can be provided.

In an example case in which the user moves the electronic device 100 in a downward direction through the guide UI 740 as illustrated in FIG. 7B, the electronic device 100 may display a preview wherein the symmetric axis is located in the first area as illustrated in FIG. 7C. Here, in an example case in which the symmetric axis is located in the first area, the electronic device 100 may provide an image effect guiding that the symmetric axis is located in the first area or a guide message. For example, the image effect may be such that at least one of the highlights 710, 720 or the symmetric axis 730 is changed to a different color or flickers, etc.

According to an embodiment, in operation S670, the electronic device 100 may determine whether an instruction for photographing (e.g., taking a picture or capturing an image) is input. Here, the instruction for photographing may be an instruction selecting an icon included in the display 120, but this is merely an example, and it may be an instruction selecting a separate physical photographing button, etc. For example, a user may input the instruction for photographing by selecting the icon on a display screen or a physical photographing button.

In an example case in which the instruction for photographing is input (e.g., S690—Y), the electronic device 100 may store the photographed image in operation S695.

According to an embodiment illustrated above, the first area is a predetermined area (e.g., the central area), but this is merely an example. As such, according to another embodiment, the first area may be identified by a preference model preferred or selected by the user. For example, the preference model may be determined according to a photographing direction of a symmetric object included in puddlegram images photographed by the user, the location of the symmetric object in the preview, and a ratio of the symmetric object included in the puddlegram images.

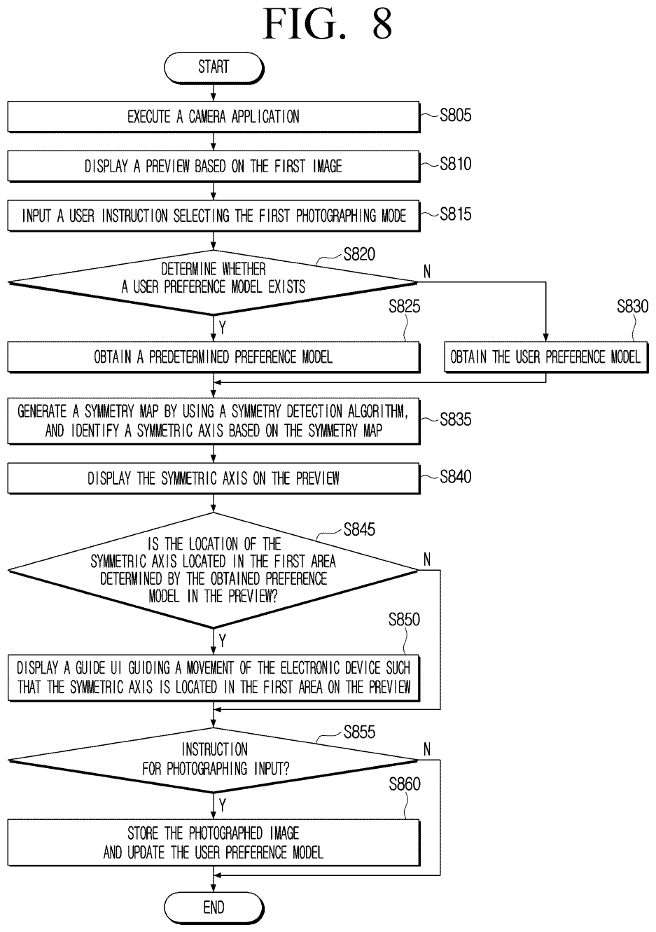

FIG. 8 is a flowchart for illustrating a method of providing a guide UI for guiding such that a symmetric axis is located in a first area corresponding to a preference model while operating in a puddlegram photographing mode according to an embodiment of the disclosure. According to an embodiment, operations S805 to S815 may be identical to the operations S310 to S330 explained in FIG. 3, and as such, overlapping explanation will be omitted.

According to an embodiment, in operation S820, the electronic device 100 may determine whether a user preference model exists (or is available). Here, the user preference model may be a model obtained by analyzing puddlegram images that were previously photographed by the user, but the disclosure is not limited thereto. For example, the user preference model may determine the first area guiding an optimal location of a symmetric axis in the preview according to the photographing direction of a symmetric object included in the puddlegram images that were previously photographed, the location of the symmetric object in the preview, and a ratio of the symmetric object included in the puddlegram images.

In an example case in which the user preference model does not exist (e.g., S820—N), the electronic device 100 may obtain a predetermined preference model in operation S825. Here, the predetermined preference model may be a preference model that determines a predetermined area (e.g., the central area of the preview) as the first area.

In an example case in which the user preference model exists (e.g., S820—Y), the electronic device 100 may obtain a user preference model in operation S830.

According to an embodiment, in operation S835, the electronic device 100 may generate a symmetry map by using the symmetry detection algorithm, and identify a symmetric axis based on the symmetry map.

According to an embodiment, in operation S840, the electronic device 100 may display the identified symmetric axis on the preview. For example, the electronic device 100 may display a highlight for the symmetric object as explained in FIG. 3, and may display the symmetric axis together.

According to an embodiment, in operation S845, the electronic device 100 may determine whether the location of the symmetric axis is located in the first area determined by the obtained preference model in the preview. Here, the first area is an area determined by the obtained preference model. In an example case in which a predetermined preference model is obtained, the first area may be the central area on the preview (e.g., an area dividing the preview in 1:1), and in example case in which the user preference model is obtained, the first area may be an area dividing the preview in a specific ratio. For example, in the user preference model, an area dividing the preview may be 1:2 ratio.

In an case example case in which it is determined that the location of the symmetric axis is beyond the first area in the preview (e.g., S845—N), the electronic device 100 may display a guide UI guiding a movement of the electronic device 100 such that the symmetric axis is located in the first area on the preview in operation S850.

For example, the electronic device 100 may analyze whether the symmetric axis is located in the first area according to the movement of the electronic device 100. In an example case in which the symmetric axis is located in the first area, the electronic device 100 may provide an image effect or a guide message guiding that the symmetric axis is located in the first area.

According to an embodiment, in operation S855, the electronic device 100 may determine whether an instruction for photographing is input. Here, the instruction for photographing may be an instruction selecting a predetermined icon included in the display 120, but this is merely an example, and it may be an instruction selecting a separate physical photographing button, etc.

In an example case in which an instruction for photographing is input (e.g., S855—Y), the electronic device 100 may store the photographed image, and update the user preference model in operation S860. For example, the electronic device 100 may analyze puddlegram images on the time point when the user's instruction for photographing was input, and obtain information on a photographing direction of a symmetric object, the location of the symmetric object in the preview, and a ratio of the symmetric object included in the puddlegram images. The electronic device 100 may update or generate a user preference model based on the obtained information.

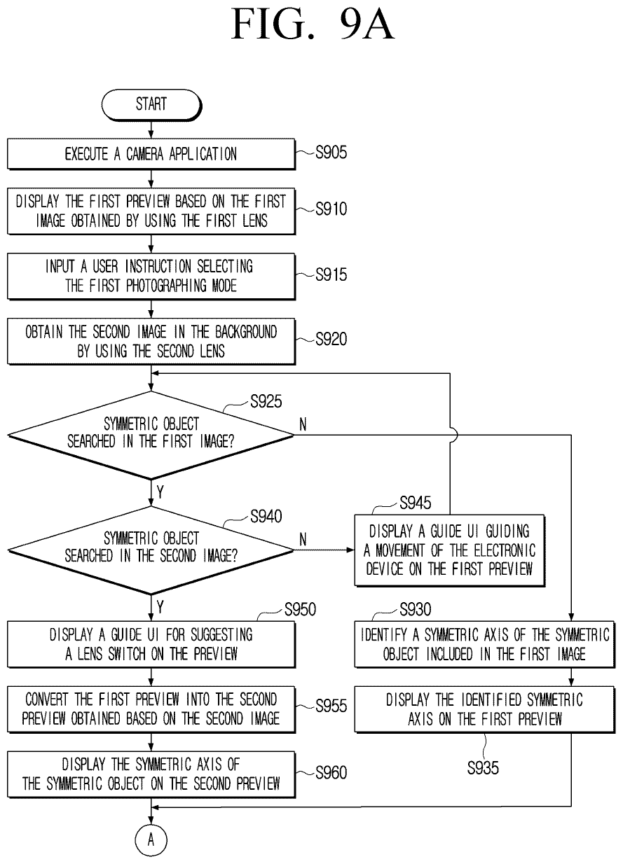

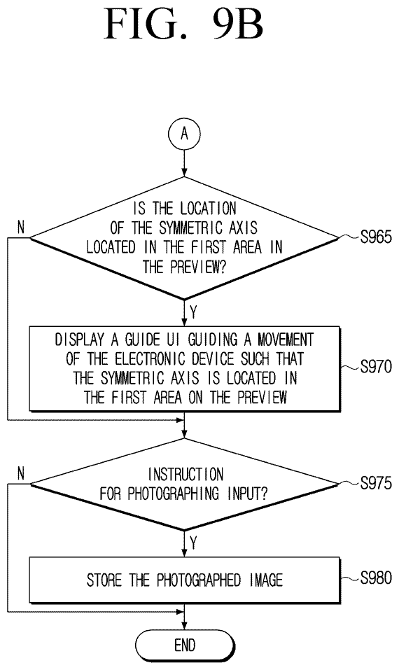

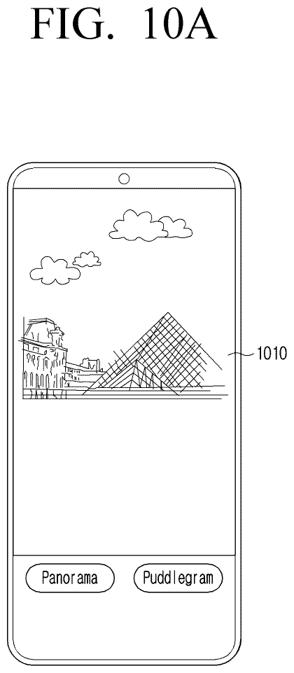

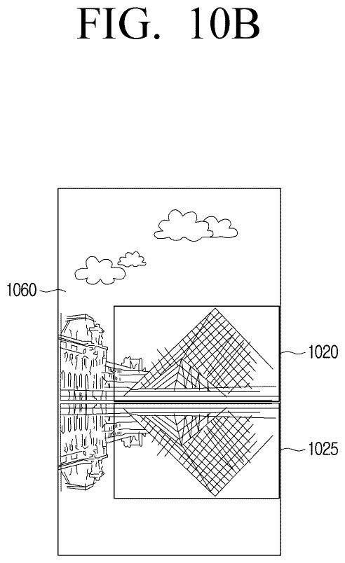

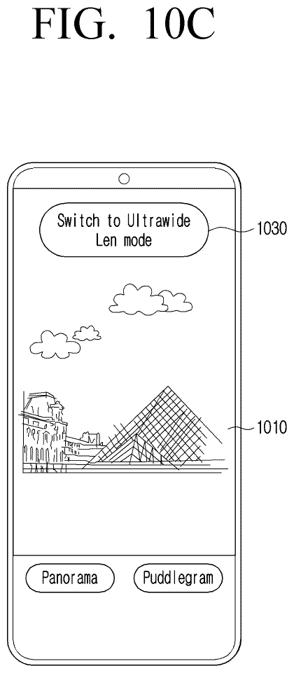

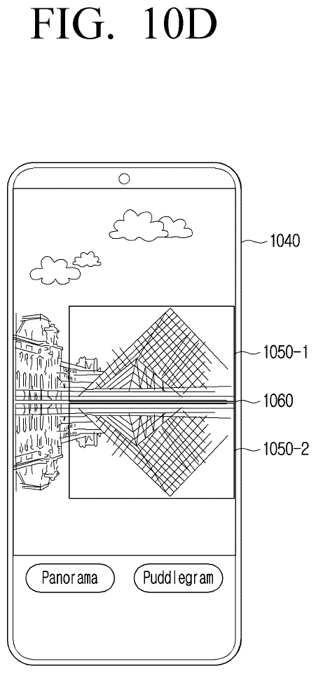

According to an embodiment, the electronic device 100 may obtain puddlegram images during the puddlegram photographing mode by using the camera 110 including a plurality of lenses. Detailed explanation in this regard will be described with reference to FIG. 9A to FIG. 9B and FIG. 10A to FIG. 10D. FIG. 9A and FIG. 9B are flowcharts for illustrating a method of performing a puddlegram photographing mode by using a plurality of lenses according to an embodiment of the disclosure.

According to an embodiment, in operation S905, the electronic device 100 may execute a camera application. For example, based on receiving a user input for executing the camera application (e.g., a user input selecting the icon of the camera application), the electronic device 100 may execute the camera application, and display an execution screen of the camera application.

According to an embodiment, in operation S910, the electronic device 100 may display a first preview based on a first image photographed through a first lens (e.g., a main lens or a wide-angle lens) in the camera 110. Here, the electronic device 100 may display a preview by performing image processing for the first image, but this is merely an example, and the electronic device 100 may display the first image itself as a preview.

According to an embodiment, in operation S915, the electronic device 100 may receive input of a user instruction selecting the first photographing mode. For example, the electronic device 100 may receive input of a user instruction selecting an icon corresponding to the first photographing mode (e.g., the puddlegram photographing mode) among the icons displayed on the preview. In an example case in which the user instruction selecting the first photographing mode is input, the electronic device 100 may enter the first photographing mode.

According to an embodiment, in operation S920, the electronic device 100 may obtain a second image in the background by using a second lens. For example, while the first preview is being displayed, the electronic device 100 may obtain a second image in the background through a second lens (e.g., an ultra wide-angle lens) different from the first lens.

According to an embodiment, in operation S925, the electronic device 100 may determine whether a symmetric object is searched in the first image. For example, the electronic device 100 may determine whether a symmetric object is searched in the first image through a symmetry map for the first image.

In an example case in which a symmetric object is searched in the first image (e.g., S925—Y), the electronic device 100 may identify a symmetric axis of the symmetric object included in the first image in operation S930. According to an embodiment, in operation S935, the electronic device 100 may display the identified symmetric axis on the first preview. Here, as illustrated in FIG. 7A, the electronic device 100 may display a highlight for the symmetric object together with the symmetric axis.

In an example case in which a symmetric object is not searched in the first image (e.g., S925—N), the electronic device 100 may determine whether a symmetric object is searched from the second image obtained in the background in operation S940.

In an example case in which a symmetric object is not searched in the second image (e.g., S940—N), the electronic device 100 may display a guide UI for guiding a movement of the electronic device 100 on the first preview in operation S945. For example, the electronic device 100 may guide the user such that a symmetric object exists in the first image or the second image through the movement of the electronic device 100.

In an example case in which a symmetric object is searched in the second image (e.g., S940—Y), the electronic device 100 may display a guide UI for suggesting a lens switch on the first preview in operation S950. For example, as illustrated in FIG. 10A, while providing the first preview 1010 based on the first image obtained through the first lens (e.g., the main lens), the electronic device 100 may not search a symmetric object from the first image. For example, as illustrated in FIG. 10B, the electronic device 100 may obtain the second image 1020 from the background 1060, and search a symmetric object 1025 from the second image. In an example case in which a symmetric object is not searched from the first image, but a symmetric object is searched from the second image, the electronic device 100 may display a guide UI 1030 for suggesting a lens switch on the first preview 1010 as illustrated in FIG. 10C.

According to an embodiment, in operation S955, the electronic device 100 may convert the first preview into the second preview obtained based on the second image. For example, in a case in which a user instruction selecting the guide UI 1030 as illustrated in FIG. 10C is input, the electronic device 100 may convert the first preview 1010 into the second preview 1040 as illustrated in FIG. 10D. According to an embodiment, in an example case in which a user instruction selecting the guide UI 1030 is input, the electronic device 100 may convert the preview, but this is merely an example. As such, according to another embodiment, when a predetermined time passes after the guide UI 1030 is displayed, the electronic device 100 may automatically convert the first preview 1010 into the second preview 1040.

According to an embodiment, in operation S960, the electronic device 100 may display the symmetric axis of the symmetric object included in the second image on the second preview. For example, as illustrated in FIG. 10D, the electronic device 100 may display the symmetric axis 1060 together with the highlights 1050-1, 1050-2 for the symmetric object on the second preview 1040.

According to an embodiment, in operation S965, the electronic device 100 may determine whether the location of the symmetric axis is located in the first area in the preview (e.g., the first preview or the second preview). Here, the first area may be a predetermined area for photographing an optimal puddlegram image, but this is merely an example, and the first area may be an area determined by the user preference model explained in FIG. 8.

In an example case in which it is determined that the location of the symmetric axis is beyond the first area in the preview (e.g., S965—N), the electronic device 100 may display a guide UI guiding a movement of the electronic device 100 such that the symmetric axis is located in the first area on the preview in operation S970.

According to an embodiment, in operation S975, the electronic device 100 may determine whether an instruction for photographing is input. Here, the instruction for photographing may be an instruction selecting a predetermined icon included in the display 120, but this is merely an example, and it may be an instruction selecting a separate physical photographing button, etc.

In an example case in which an instruction for photographing is input (e.g., S975—Y), the electronic device 100 may store the photographed image in operation S980.

According to an embodiment, the display 120 included in the electronic device 100 according to an embodiment of the disclosure may be implemented as a plurality of displays including a flexible display and a rigid display, and may be implemented as various form factors. Also, while the electronic device 100 is folded by a first angle, the electronic device 100 may generate a reflective object that is an object reflected through a reflective surface which is a part of the flexible display in the display 120, and obtain a symmetric object. More detailed explanation in this regard will be described with reference to FIGS. 11A to 11C, FIGS. 12A to 12C, FIG. 13, FIGS. 14A to 14C, FIG. 15, FIG. 16, FIGS. 17A to 17C and FIGS. 18A to 18C.

FIG. 11A to FIG. 11C are diagrams for illustrating form factors of an electronic device according to various embodiments of the disclosure. According to an embodiment of the disclosure, a flexible display may be arranged on one surface (e.g., the front surface) of the electronic device 100, and a rigid display or a flexible display may be arranged on the other surface (e.g., the rear surface) of the electronic device 100. For example, the electronic device 100 may further include a hinge part that makes the electronic device 100 folded or unfolded, and the display 120 (e.g., the flexible display) may be folded or unfolded as the electronic device 100 is folded or unfolded centered around the hinge part.

According to an embodiment of the disclosure, as illustrated in the upper part of FIG. 11A, a first display 1110 may be arranged in one area of the first surface (e.g., the rear surface) of the electronic device 100, and as illustrated in the lower part of FIG. 11A, the second display 1120 may be arranged on the second surface (e.g., the front surface) of the electronic device 100. For example, as illustrated in the upper part of FIG. 11A, the first display 1110 is a rigid display in a quadrangle form wherein the horizontal length is longer, and for example, the first display 1110 may have a size of 4.6 inches in a ratio of 21:9, and support a resolution of 1680×720, but the disclosure is not limited thereto. Also, as illustrated in the lower part of FIG. 11A, the second display 1120 is a flexible display that can be folded or unfolded by the hinge part, and the second display 1120 may have a size of 7.3 inches in a ratio of 7:5, and support a resolution of 2152×1536.

Also, the electronic device 100 may be folded by an in-folding method wherein the first area 1120-1 and the second area 1120-2 of the second display 1120 are folded to face each other based on the hinge part.

In addition, the electronic device 100 may include the camera 110 in the first area 1120-1 of the second display 1120. Here, the camera 110 may be implemented as an under-display camera, and as illustrated in FIG. 11A, the camera 110 may be arranged in the upper central area of the first area 1120-1. However, this is merely an example, and for obtaining a more effective puddlegram image, the camera 110 may be arranged in the central area of the first area 1120-1 to be closer to the hinge part.

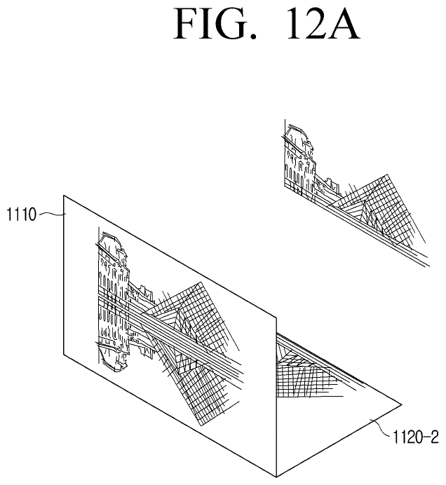

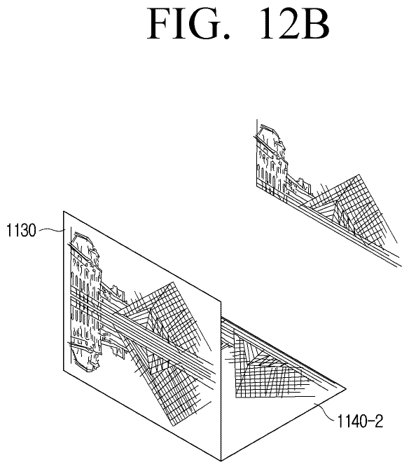

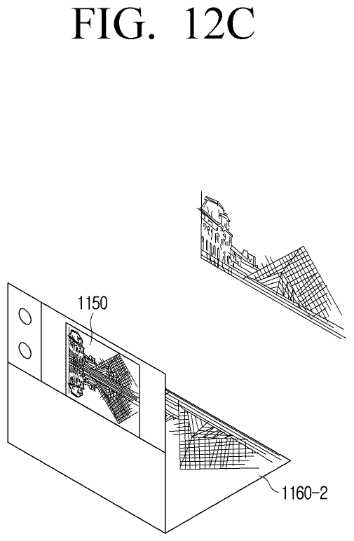

For example, the second area 1120-2 of the second display 1120 may perform a role of a reflective surface. For example, as illustrated in FIG. 12A, while the second display 1120 is folded by the first angle by the hinge part, an actual object may be reflected by the second area 1120-2 which is a reflective surface, and a reflective object may be generated. By this, the electronic device 100 may photograph a puddlegram image including a symmetric object including an actual object and a reflective object, and provide a preview on the first display 1110.

According to another embodiment of the disclosure, as illustrated in the upper part of FIG. 11B, the first display 1130 may be arranged in one area of the first surface (e.g., the rear surface) of the electronic device 100, and as illustrated in the lower part of FIG. 11B, the second display 1140 may be arranged on the second surface (e.g., the front surface) of the electronic device 100. For example, as illustrated in the upper part of FIG. 11B, the first display 1130 is a rigid display in a quadrangle form, and for example, it may have a size of 3.2 inches in a ratio of 11:9, and support a resolution of 1320×1080. Also, as illustrated in the lower part of FIG. 11B, the second display 1140 is a flexible display in a form wherein the vertical length is longer that can be folded or unfolded by the hinge part, and for example, it may have a size of 6.7 inches in a ratio of 22:9, and support a resolution of 2640×1080.

Also, the electronic device 100 may be folded by an in-folding method wherein the first area 1140-1 and the second area 1140-2 of the second display 1140 are folded to face each other based on the hinge part.

In addition, the electronic device 100 may include the camera 110 in the first area 1140-1 of the second display 1140. Here, the camera 110 may be implemented as an under-display camera, and as illustrated in the lower part of FIG. 11B, the camera 110 may be arranged in the upper central area of the first area 1140-1. However, this is merely an example, and for obtaining a more effective puddlegram image, the camera 110 may be arranged in the central area of the first 1140-1 to be closer to the hinge part.

According to an embodiment, the second area 1140-2 of the second display 1140 may perform a role of a reflective surface. For example, as illustrated in FIG. 12B, while the second display 1140 is folded by the first angle by the hinge part, an actual object may be reflected by the second area 1140-2 which is a reflective surface, and a reflective object may be generated. By this, the electronic device 100 may photograph a puddlegram image including a symmetric object including an actual object and a reflective object, and provide a preview on the first display 1130.

According to an embodiment, the first display 1130 may be implemented as a rigid display, but this is merely an example, and it may be implemented as a flexible display arranged on the first surface of the electronic device 100.

According to another embodiment of the disclosure, as illustrated in the upper part of FIG. 11C, the first display 1150 may be arranged in one area of the first surface (e.g., the rear surface) of the electronic device 100, and as illustrated in the lower part of FIG. 11C, the second display 1160 may be arranged on the second surface (e.g., the front surface) of the electronic device 100. For example, as illustrated in the upper part of FIG. 11C, the first display 1150 is a rigid display in a quadrangle form arranged in some areas of the first surface, and for example, it may have a size of 1.9 inches in a ratio of 1.97:1, and support a resolution of 512×260. As the explanation below will be identical to the explanation related to FIG. 11B, overlapping explanation will be omitted.

For example, the second area 1160-2 of the second display 1160 may perform a role of a reflective surface. For example, as illustrated in FIG. 12C, while the second display 1160 is folded by the first angle by the hinge part, an actual object may be reflected by the second area 1160-2 which is a reflective surface, and a reflective object may be generated. By this, the electronic device 100 may photograph a puddlegram image including a symmetric object including an actual object and a reflective object, and provide a preview on the first display 1150.

For example, for photographing an optimal puddlegram image while operating in the first photographing mode in a state wherein the electronic device 100 is folded by the first angle, the electronic device 100 may display a guide UI guiding folding of the electronic device 100 so as to move the symmetric axis to a predetermined area.

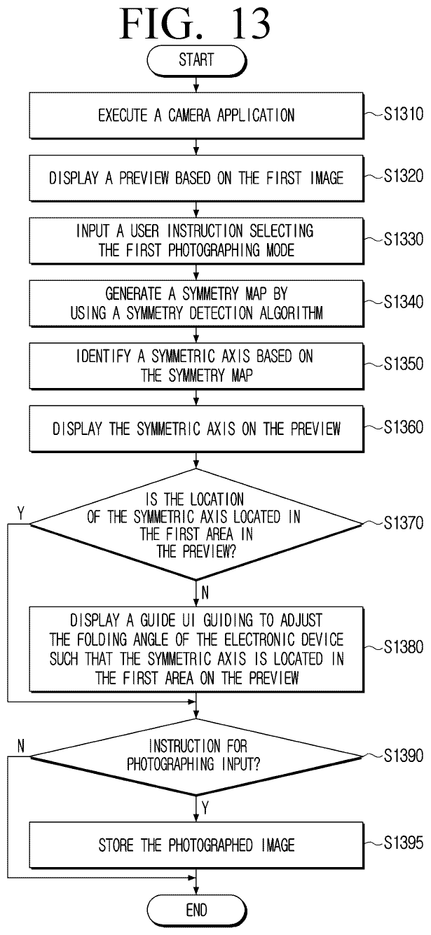

FIG. 13 is a flowchart for illustrating a method of providing a guide UI that guides folding or unfolding of an electronic device such that a symmetric axis is located in a first area while operating in a puddlegram photographing mode according to an embodiment of the disclosure.

According to an embodiment in operation S1310, the electronic device 100 may execute the camera application. In an example case in which a user input for executing the camera application (e.g., a user input selecting the icon of the camera application) is received, the electronic device 100 may execute the camera application, and display an execution screen of the camera application. Here, the electronic device 100 may be in a state of being folded by the first angle.

According to an embodiment in operation S1320, the electronic device 100 may display a preview based on the first image. Here, the electronic device 100 may display a preview based on the first image photographed through the wide-angle lens in the camera 110. Here, the electronic device 100 may display the preview by performing image processing for the first image, but this is merely an example, and the electronic device 100 may display the first image itself as the preview. For example, the electronic device 100 may display the preview on the first display 1110, 1130, 1150 while being folded by the first angle.

According to an embodiment in operation S1330, the electronic device 100 may receive input of a user instruction selecting the first photographing mode. For example, the electronic device 100 may receive input of a user instruction selecting the icon corresponding to the first photographing mode (e.g., the puddlegram photographing mode) among the icons displayed on the preview. In an example case in which the user instruction selecting the first photographing mode is input, the electronic device 100 may operate in the first photographing mode.

According to an embodiment in operation S1340, the electronic device 100 may generate a symmetry map by using the symmetry detection algorithm, and in operation S1350, the electronic device 100 may identify a symmetric axis based on the symmetry map.

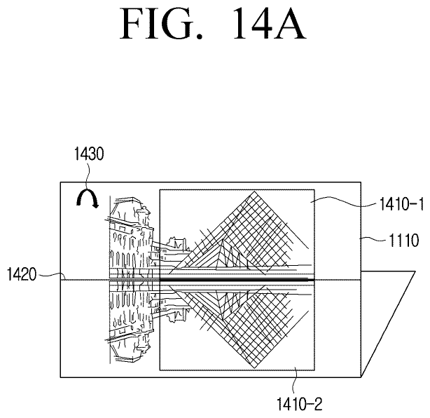

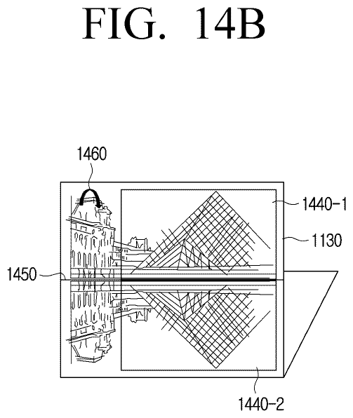

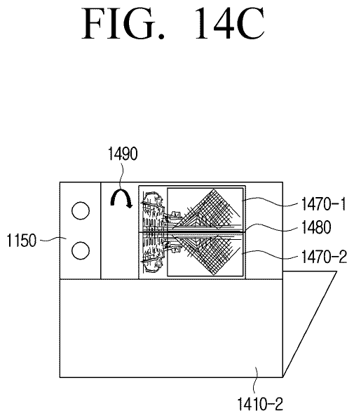

According to an embodiment in operation S1360, the electronic device 100 may display the symmetric axis on the preview. Here, as illustrated in FIG. 14A to FIG. 14C, the electronic device 100 may display the symmetric axis 1420, 1450, 1480 on the first display 1110, 1130, 1150. In addition, as illustrated in FIG. 14A to FIG. 14C, the electronic device 100 may display the highlight 1410-1, 1440-1, 1470-1 for the actual object and the highlight 1410-2, 1440-2, 1470-2 for the reflective object together with the symmetric axis 1420, 1450, 1480.

According to an embodiment in operation S1370, the electronic device 100 may determine whether the location of the symmetric axis is located in the first area in the preview. Here, the first area is a predetermined area for photographing an optimal puddlegram image, and for example, it may be the central area of the preview, but this is merely an example, and the first area may be an area determined by the user preference model.

In an example case in which it is determined that the location of the symmetric axis is beyond the first area in the preview (e.g., S1370—N), the electronic device 100 may display a guide UI guiding to adjust the folding angle of the electronic device 100 such that the symmetric axis is located in the first area on the preview in operation S1380. For example, while the electronic device 100 is folded by the first angle (e.g., the angle between the first area and the second area of the second display is 95 degrees), based on a determination that the location of the symmetric axis is beyond the first area of the preview, the electronic device 100 may display a guide UI 1430, 1460, 1490 guiding folding of the electronic device 100, as illustrated in FIG. 14A to FIG. 14C. Here, as illustrated in FIG. 14A to FIG. 14C, the electronic device 100 may display the guide UI 1430, 1460, 1490 in the form of an arrow guiding folding of the electronic device 100, but this is merely an example, and as such, according to another embodiment, a text message or a voice message guiding folding of the electronic device 100 can be provided together.

According to an embodiment, the electronic device 100 may determine folding or unfolding of the electronic device 100 according to the location of the symmetric axis. In an example case in which it is determined that the symmetric axis is located lower than the first area, the electronic device 100 may display a guide UI guiding folding of the electronic device 100, and in an example case in which it is determined that the symmetric axis is located upper than the first area, the electronic device 100 may display a guide UI guiding unfolding of the electronic device 100.

In addition, while it was explained in FIG. 14A to FIG. 14C that a guide UI in the form of an arrow guiding folding or unfolding of the electronic device 100 is provided according to an embodiment, this is merely an example. As such, according to another embodiment, a guide UI guiding zoom-in/zoom-out or guiding the electronic device 100 (or the camera 110) to move or rotate (in particular, rotation in a pitch direction) may be provided.

In an example case in which the user folds the electronic device 100 by a second angle (e.g., 80 degrees) through the guide UI 1430, 1460, 1490 as illustrated in FIG. 14A to FIG. 14C, the electronic device 100 may display a preview wherein the symmetric axis is located in the first area. Here, in an example case in which the symmetric axis is located in the first area, the electronic device 100 may provide an image effect guiding that the symmetric axis is located in the first area (e.g., an image effect that at least one of the highlights 710, 720 or the symmetric axis 730 is changed to a different color or flickers, etc.) or a guide message, and remove the guide UI 1430, 1460, 1490 from the preview.

According to an embodiment in operation S1390, the electronic device 100 may determine whether an instruction for photographing is input. Here, the instruction for photographing may be an instruction selecting a predetermined icon included in the first display 1110, 1130, 1150, but this is merely an example, and it may be an instruction selecting a separate physical photographing button, etc.

in an example case in which an instruction for photographing is input (e.g., S1390—Y), the electronic device 100 may store the photographed image in operation S1395.

As in the case of a form factor illustrated in FIG. 11B and FIG. 11C among the plurality of form factors, in case the camera 110 is not located to be close to the hinge part (e.g., in case the camera 110 is located in the upper part), when a symmetric object is not searched, the electronic device 100 may provide a guide UI guiding the user such that the electronic device 100 is moved to be closer to an object on the preview.

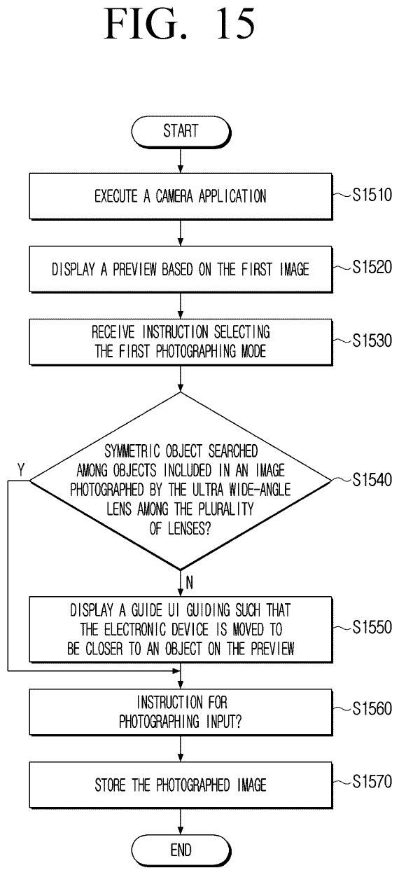

FIG. 15 is a flowchart for illustrating a method of providing a guide UI that guides a movement of an electronic device to detect a symmetric object while operating in a puddlegram photographing mode according to an embodiment of the disclosure.

According to an embodiment, in operation S1510, the electronic device 100 may execute the camera application. For example, based on receiving a user input for executing the camera application (e.g., a user input selecting the icon of the camera application), the electronic device 100 may execute the camera application, and display an execution screen of the camera application. Here, the electronic device 100 may be in a state of being folded by the first angle.

According to an embodiment, in operation S1520, the electronic device 100 may display a preview based on the first image. Here, the electronic device 100 may display a preview based on the first image photographed through the first lens in the camera 110. For example, the electronic device 100 may display a preview on the first display 1110, 1130, 1150 while being folded by the first angle.

According to an embodiment, in operation S1530, the electronic device 100 may receive input of a user instruction selecting the first photographing mode. For example, the electronic device 100 may receive input of a user instruction selecting an icon corresponding to the first photographing mode (e.g., the puddlegram photographing mode) among the icons displayed on the preview. In an example case in which the user instruction selecting the first photographing mode is input, the electronic device 100 may operate in the first photographing mode.

According to an embodiment, in operation S1540, the electronic device 100 may determine whether a symmetric object is searched among objects included in an image photographed by the ultra wide-angle lens among the plurality of lenses. Here, the electronic device 100 may provide a preview based on the image photographed by the ultra wide-angle lens, but this is merely an example, and the electronic device 100 may photograph an image by the ultra wide-angle lens in the background.

In an example case in which a symmetric object is not searched (e.g., S1540—N), the electronic device 100 may display a guide UI guiding such that the electronic device 100 is moved to be closer to an object on the preview in operation S1550. In an example case in which a symmetric object is searched in the image photographed by the ultra wide-angle lens after the electronic device 100 moved according to the guide UI, the electronic device 100 may display a symmetric axis and a highlight for the searched symmetric object. Then, as explained above, in case the symmetric axis is beyond the first area, the electronic device 100 may also provide a guide UI guiding a movement of the electronic device 100 on the preview. In an example case in which a symmetric object is searched (e.g., S1540—Y), the electronic device 100 may proceed to operation S1560.

According to an embodiment, in operation S1560, the electronic device 100 may determine whether an instruction for photographing is input.

In an example case in which a an instruction for photographing is input in operation S1560, the electronic device 100 may store the photographed image in operation S1570.

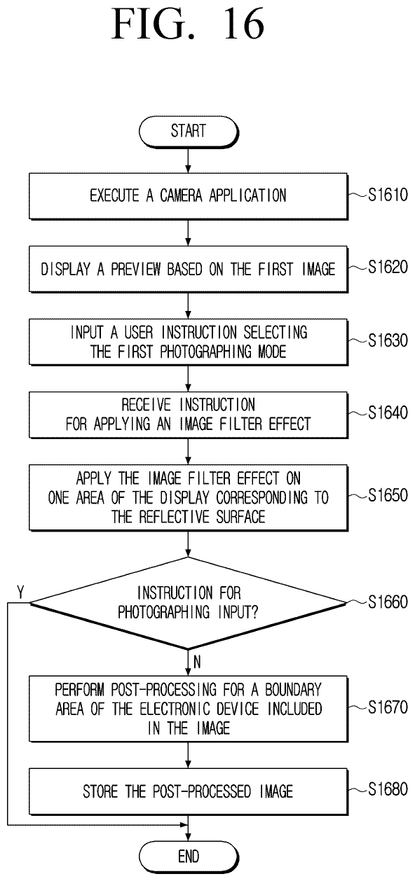

FIG. 16 is a flowchart for illustrating a method of providing an image filter effect on a reflective surface while operating in a puddlegram photographing mode according to an embodiment of the disclosure. As the operations S1610 to S1630 illustrated in FIG. 16 may be identical to the operations S1310 to S1330 in FIG. 13, overlapping explanation will be omitted.

According to an embodiment, in operation S1640, the electronic device 100 may receive input of a user instruction for applying an image filter effect. Here, the user instruction for applying the image filter effect may be a user instruction selecting an icon corresponding to the image filter effect displayed on the first display 1110, 1130, 1150.

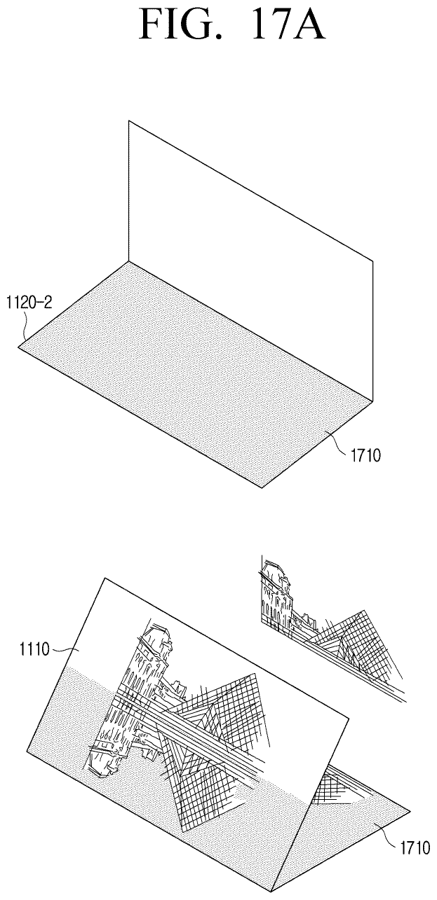

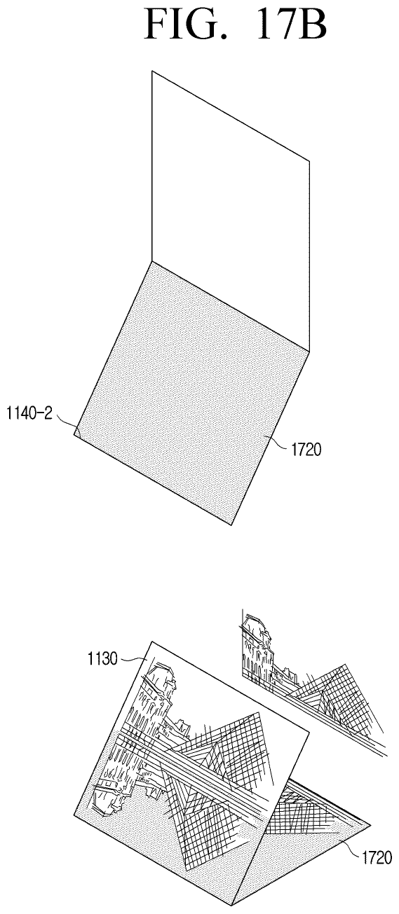

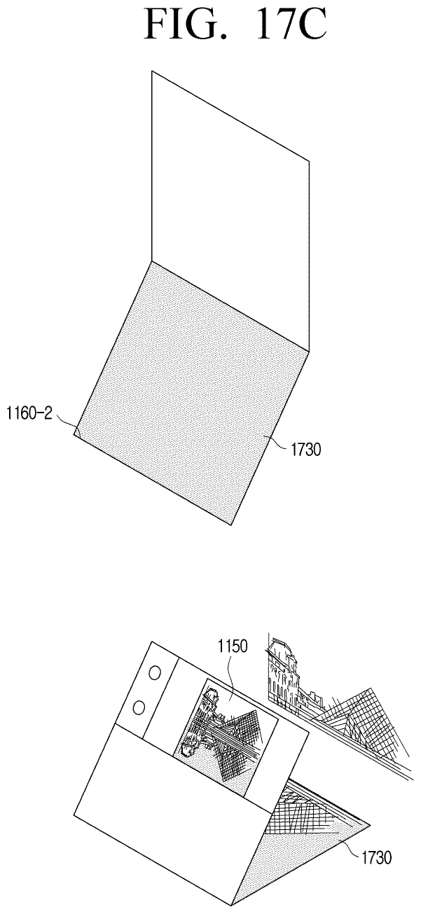

According to an embodiment, in operation S1650, the electronic device 100 may apply the image filter effect on one area of the display 120 corresponding to the reflective surface. For example, as illustrated in the upper part of FIG. 17A, the upper part of FIG. 17B, and the upper part of FIG. 17C, the electronic device 100 may provide the image filter effect 1710, 1720, 1730 on the second area 1120-2, 1140-2, 1160-2 of the second display 1120, 1140, 1160. Here, the image filter effect may be an effect of displaying a predetermined color (e.g., blue, etc.) or a predetermined pattern on the second area 1120-2, 1140-2, 1160-2.

Here, the image filter effect may be a predetermined image filter, but this is merely an example, and it may be an image filter selected by the user among the plurality of image filters.

Here, as illustrated in the lower part of FIG. 17A, the lower part of FIG. 17B, and the lower part of FIG. 17C, the electronic device 100 may identify a puddlegram image to which the image filter effect provided on the reflective surface is applied through the preview displayed on the first display 1110, 1130, 1150 of the electronic device 100. Then, the user may select an image filter that matches the current image the best among the plurality of image filters.

According to an embodiment, in operation S1660, the electronic device 100 may determine whether an instruction for photographing is input.

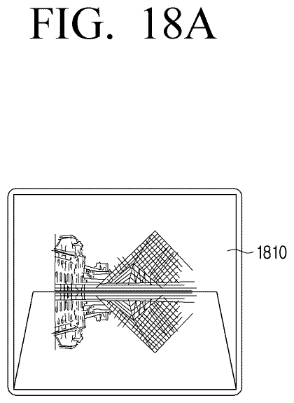

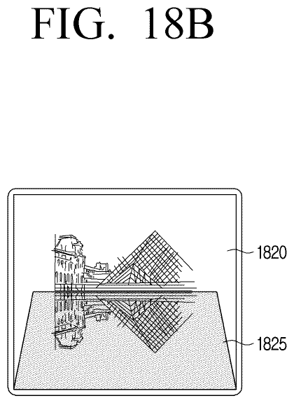

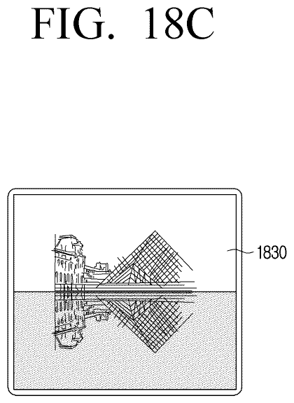

In an example case in which an instruction for photographing is input (e.g., S1660—Y), the electronic device 100 may perform post-processing for a boundary area of the electronic device 100 included in the image in operation S1670. For example, in the case of photographing a puddlegram image including a reflective object that was reflected by the reflective surface, as illustrated in FIG. 18A, the electronic device 100 may provide a preview 1810 including a boundary area of the reflective surface (e.g., the second area 1120-2, 1140-2, 1160-2 of the second display 1120, 1140, 1160) of the electronic device 100. Also, as illustrated in FIG. 18B, in case an image filter effect 1825 is applied to the reflective surface (e.g., the second area 1120-2, 1140-2, 1160-2 of the second display 1120, 1140, 1160) of the electronic device 100, the electronic device 100 may provide a preview 1820 including a boundary area of the reflective surface to which the image filter effect 1825 is applied. Here, as illustrated in FIG. 18C, the electronic device 100 may remove the boundary area of the reflective surface, and perform post-processing such that the image filter effect is applied to the entire area corresponding to the reflective surface based on the symmetric axis, and provide a post-processed preview 1830. By this, the user can obtain a puddlegram image not included in the boundary area of the electronic device 100, and can thereby obtain a puddlegram image including a reflective object that looks as if it was reflected by an actual reflective surface (e.g., water, etc.) but not the reflective surface of the electronic device 100.

According to an embodiment, in operation S1680, the electronic device 100 may store the post-processed image.

According to an embodiment described above, post-processing for the boundary area of the electronic device included in an image may be performed after an instruction for photographing is input, but this is merely an example, and post-processing for the boundary area of the electronic device included in an image may be performed in real time, and an image wherein the boundary area was removed may be provided on the preview.

Also, in the aforementioned embodiment, a predetermined image filter effect may be applied, but this is merely an example, and a plurality of recommended image filter effects may be provided by analyzing information detected by the sensor and a currently photographed image. According to an embodiment, the electronic device 100 may determine a recommended image filter effect for recommending to the user based on information on the ambient brightness detected by the sensor 150, information on colors included in an image, and information on objects included in an image. In an example case in which a recommended image filter effect is selected, the electronic device 100 may control the display 120 to display the recommended image filter effect in at least some areas of the display 120.

According to an embodiment illustrated above, based on a user instruction for entering the first photographing mode being input, the electronic device 100 enters the first photographing mode, but this is merely an example. As such, according to another embodiment, the electronic device 100 may enter the photographing mode automatically as the first photographing mode according to a folding angle by which it is currently folded without a separate user input.

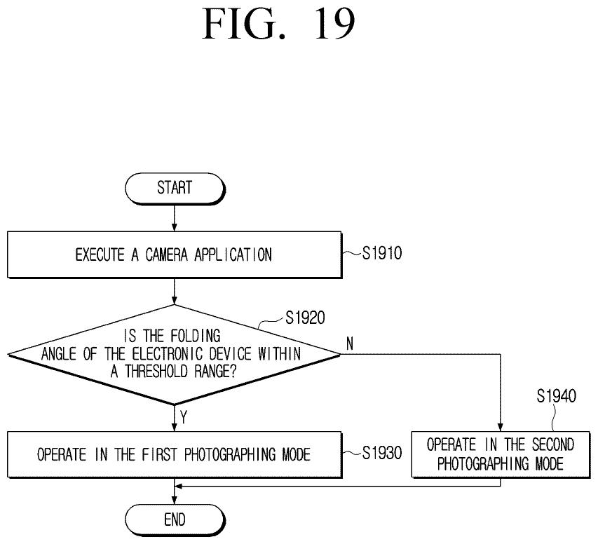

FIG. 19 is a flowchart for illustrating a method of entering a puddlegram photographing mode automatically according to a folding angle of an electronic device according to an embodiment of the disclosure.

According to an embodiment, in operation S1910, the electronic device 100 may execute the camera application. For example, in a case in which a user input for executing the camera application (e.g., a user input selecting the icon of the camera application) is received, the electronic device 100 may execute the camera application, and display an execution screen of the camera application.

According to an embodiment, in operation S1920, the electronic device 100 may determine whether the folding angle of the electronic device 100 is within a threshold range. For example, the electronic device 100 may determine whether the folding angle between the first area 1120-1, 1140-1, 1160-1 and the second area 1120-2, 1140-2, 1160-2 of the second display 1120, 1140, 1160 (illustrates in FIGS. 7A-7C) is within a threshold range (e.g., between 70 and 80 degrees).

In an example case in which the folding angle of the electronic device 100 is within the threshold range (e.g., S1920—Y), the electronic device 100 may operate in the first photographing mode in operation S1930. That is, in an example case in which the electronic device 100 is folded by the first angle within the threshold range, the electronic device 100 may operate in the puddlegram photographing mode.

In an example case in which the folding angle of the electronic device 100 is beyond the threshold range (e.g., S1920—N), the electronic device 100 may operate in the second photographing mode in operation S1940. Here, the second photographing mode may be a normal mode, but this is merely an example, and it may be a different photographing mode (e.g., a self photographing mode, a panorama photographing mode, etc.).

According to an embodiment described above, the electronic device 100 searches a symmetric object through a symmetry detection algorithm, but this is merely an example. For example, the electronic device 100 may search a symmetric object in an image through a trained neural network model. For example, the electronic device 100 may obtain information on a symmetric object by inputting an image into a trained neural network model.

According to an embodiment, in FIG. 3 to FIG. 19, various embodiments were explained, but the various embodiments can be operated as a combination of a plurality of embodiments, but not as separate embodiments. Also, explanation for one embodiment can be applied to another embodiment.

According to an embodiment, operations and functions related to artificial intelligence according to the disclosure may be operated through the processor and the memory of the electronic device 100.

The processor may include one or a plurality of processors. Here, the one or plurality of processors may include at least one of a central processing unit (CPU), a graphic processing unit (GPU), or a neural processing unit (NPU), but the processors are not limited to the aforementioned examples of processors.

According to an embodiment, a CPU is a generic-purpose processor that can perform not only general operations but also artificial intelligence operations, and it can effectively execute a complex program through a multilayer cache structure. For example, a CPU may be advantageous for a serial processing method that enables a systemic linking between the previous calculation result and the next calculation result through sequential calculations. A generic-purpose processor is not limited to the aforementioned examples excluding cases wherein it is specified as the aforementioned CPU.

According to an embodiment, a GPU is a processor for mass operations such as a floating point operation used for graphic processing, etc., and it can perform mass operations in parallel by massively integrating cores. For example, a GPU may be advantageous for a parallel processing method such as a convolution operation, etc. compared to a CPU. Also, a GPU may be used as a co-processor for supplementing the function of a CPU. A processor for mass operations is not limited to the aforementioned examples excluding cases wherein it is specified as the aforementioned GPU.

According to an embodiment, an NPU is a processor specialized for an artificial intelligence operation using an artificial neural network, and it can implement each layer constituting an artificial neural network as hardware (e.g., silicon). Here, the NPU is designed to be specialized according to the required specification of a company, and thus it has a lower degree of freedom compared to a CPU or a GPU, but it can effectively process an artificial intelligence operation required by the company. According to an embodiment, as a processor specialized for an artificial intelligence operation, an NPU may be implemented in various forms such as a tensor processing unit (TPU), an intelligence processing unit (IPU), a vision processing unit (VPU), etc. An artificial intelligence processor is not limited to the aforementioned examples excluding cases wherein it is specified as the aforementioned NPU.

Also, the one or plurality of processors may be implemented as a system on chip (SoC). Here, in the SoC, the memory, and a network interface such as a bus for data communication between the processor and the memory, etc. may be further included other than the one or plurality of processors.

In case the plurality of processors are included in the system on chip (SoC) included in the electronic device, the electronic device may perform an operation related to artificial intelligence (e.g., an operation related to learning or inference of the artificial intelligence model) by using some processors among the plurality of processors. For example, the electronic device may perform an operation related to artificial intelligence by using at least one of a GPU, an NPU, a VPU, a TPU, or a hardware accelerator specified for artificial intelligence operations such as a convolution operation, a matrix product operation, etc. among the plurality of processors. However, this is merely an example, and as such, according to another embodiment, the electronic device may be configured to process an operation related to artificial intelligence by using the generic-purpose processor such as a CPU, etc.

Also, the electronic device may perform operations for functions related to artificial intelligence by using a multicore (e.g., a dual core, a quad core, etc.) included in one processor. In particular, the electronic device may perform artificial intelligence operations such as a convolution operation, a matrix product operation, etc. in parallel by using the multicore included in the processor.

The one or plurality of processors perform control such that input data is processed according to predefined operation rules or an artificial intelligence model stored in the memory. The predefined operation rules or the artificial intelligence model are characterized in that they are made through learning.

Here, being made through learning means that predefined operation rules or an artificial intelligence model having desired characteristics are made by applying a learning algorithm to a plurality of training data. Such learning may be performed in a device itself wherein artificial intelligence is performed according to the disclosure, or through a separate server/system.

An artificial intelligence model may include a plurality of neural network layers. At least one layer has at least one weight value, and performs an operation of the layer through the operation result of the previous layer and at least one defined operation. As examples of a neural network, there are a convolutional neural network (CNN), a deep neural network (DNN), a recurrent neural network (RNN), a restricted Boltzmann Machine (RBM), a deep belief network (DBN), a bidirectional recurrent deep neural network (BRDNN), deep Q-networks, and a transformer, but the neural network in the disclosure is not limited to the aforementioned examples excluding specified cases.

A learning algorithm is a method of training a specific subject device (e.g., a robot) by using a plurality of training data and thereby making the specific subject device make a decision or make prediction by itself. As examples of learning algorithms, there are supervised learning, unsupervised learning, semi-supervised learning, or reinforcement learning, but learning algorithms in the disclosure are not limited to the aforementioned examples excluding specified cases.

According to an embodiment, the method according to the various embodiments of the disclosure may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or may be distributed directly between two user devices (e.g.: smartphones), and distributed on-line (e.g.: download or upload) through an application store (e.g.: Play Store™). In the case of on-line distribution, at least a portion of a computer program product (e.g.: a downloadable app) may be stored in a storage medium such as the server of the manufacturer, the server of the application store, and the memory of the relay server at least temporarily, or may be generated temporarily.

Also, the method according to the various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: a TV).

According to an embodiment, a storage medium readable by machines may be provided in the form of a non-transitory storage medium. Here, the term ‘a non-transitory storage medium’ only means that the device is a tangible device, and does not include signals (e.g.: electromagnetic waves), and the term does not distinguish a case wherein data is stored in the storage medium semi-permanently and a case wherein data is stored temporarily. For example, ‘a non-transitory storage medium’ may include a buffer wherein data is temporarily stored.

In case an instruction is executed by the processor, the processor may perform a function corresponding to the instruction by itself, or by using other components under its control. An instruction may include a code that is generated or executed by a compiler or an interpreter.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic device comprising:
a camera comprising a plurality of lenses;
a display;
a memory storing at least one instruction; and
at least one processor that is connected with the camera, the display, and the memory, and, by executing the at least one instruction, configured to:
control the display to display a preview based on an image obtained by the camera,
based on a selection of a first photographing mode, search for a symmetric object among a plurality of objects in the image, and
perform a focusing operation on the symmetric object.

2. The electronic device of claim 1,
wherein the at least one processor is further configured to:
obtain a symmetry map by using a symmetry detection algorithm,
search the symmetric object among the plurality of objects in the image by using the symmetry map, and
control the display to display a highlight corresponding to the symmetric object on the preview.

3. The electronic device of claim 2,
wherein the at least one processor is further configured to:
identify a symmetric axis of the symmetric object by using the symmetry map,
control the display to display the symmetric axis on the preview,
determine whether a location of the symmetric axis is in a first area in the preview, and
based on a determination that the location of the symmetric axis is not in the first area in the preview, control the display to display a first guide information for guiding a movement of the electronic device such that the symmetric axis is located in the first area on the preview.

4. The electronic device of claim 3,
wherein the first area is determined according to a photographing direction of a symmetric object included in a puddlegram image photographed by a user, the location of the symmetric object in the preview, and a ratio of the symmetric object included in the puddlegram image.

5. The electronic device of claim 3,
wherein the at least one processor is further configured to:
control the display to display a first preview based on a first image photographed by using a first lens among the plurality of lenses,
based on the selection of the first photographing mode being input while the first preview is displayed, obtain a second image of a background by using a second lens different from the first lens among the plurality of lenses,
based on the symmetric object not being searched in the first image and the symmetric object being searched in the second image, control the display to convert the first preview into a second preview obtained based on the second image,
identify the symmetric axis of the symmetric object in the second image, and
control the display to display the symmetric axis on the second preview.

6. The electronic device of claim 1, further comprising:
a hinge part configured to fold and unfold the electronic device folded or unfolded, wherein the display is folded or unfolded as the electronic device is folded or unfolded centered around the hinge part, and
wherein the at least one processor is further configured to:
based on the selection of the first photographing mode being input while the electronic device is folded by a first angle by the hinge part, identify a symmetric axis of the symmetric object, among the plurality of objects, generated by a reflective surface among a plurality of surfaces in the electronic device, and
control the display to display the symmetric axis on the preview,
determine whether a location of the symmetric axis is in the first area in the preview, and
based on a determination that the location of the symmetric axis not in the first area in the preview, control the display to display a first guide information for an adjustment of a folding angle of the electronic device so as to locate the symmetric axis in the first area on the preview.

7. The electronic device of claim 6,
wherein the at least one processor is configured to:
based on the selection of the first photographing mode being input while the electronic device is folded by the first angle by the hinge part, determine whether the symmetric object is searched among the plurality of objects in the image photographed by an ultra wide-angle lens, among the plurality of lenses, and
based on the symmetric object not being searched, control the display to display a second guide information for guiding a movement of the electronic device to be closer to an object on the preview.

8. The electronic device of claim 6,
wherein the reflective surface is a surface in which one or more parts of the display are arranged, and
wherein the at least one processor is further configured to:
control the display to display an image filter effect on one or more parts of the display.

9. The electronic device of claim 8, further comprising:
a sensor configured to detect information on an ambient environment,
wherein the at least one processor is further configured to:
determine a recommended image filter effect for recommending to a user based on information on the ambient environment detected by the sensor, information on colors in the image, and information on the plurality of objects in the image, and
based on the recommended image filter effect being selected, control the display to display the recommended image filter effect in the one or more parts of the display.

10. The electronic device of claim 6,
wherein the at least one processor is further configured to:
based on a camera application being executed while the electronic device is folded by the first angle by the hinge part, automatically enter the first photographing mode.

11. A control method for an electronic device, the method comprising:
displaying a preview based on an image obtained by a camera of the electronic device;
based on a selection of a first photographing mode, searching for a symmetric object among a plurality of objects in the image; and
performing a focusing operation on the symmetric object.

12. The control method of claim 11,
wherein the searching for the symmetric object further comprises:
obtaining a symmetry map by using a symmetry detection algorithm; and
searching the symmetric object among the plurality of objects in the image by using the symmetry map, and
wherein the control method further comprises:
displaying a highlight corresponding to the symmetric object on the preview.

13. The control method of claim 12, further comprising:
identifying a symmetric axis of the symmetric object by using the symmetry map;
displaying the symmetric axis on the preview;
determining whether a location of the symmetric axis is in a first area in the preview; and
based on a determination that the location of the symmetric axis is not in the first area in the preview, displaying a first guide information for guiding a movement of the electronic device such that the symmetric axis is located in the first area on the preview.

14. The control method of claim 13,
wherein the first area is determined according to a photographing direction of a symmetric object included in a puddlegram image photographed by a user, the location of the symmetric object in the preview, and a ratio of the symmetric object included in the puddlegram image.

15. The control method of claim 13,
wherein the displaying the preview comprises:
displaying a first preview based on a first image photographed by using a first lens among a plurality of lenses included in the camera, and
wherein the control method further comprises:
based on the selection of the first photographing mode being input while the first preview is displayed, obtaining a second image of a background by using a second lens different from the first lens among the plurality of lenses;
based on the symmetric object not being searched in the first image and the symmetric object being searched in the second image, converting the first preview into a second preview obtained based on the second image;
identifying the symmetric axis of the symmetric object in the second image; and
displaying the symmetric axis on the second preview.
